(19) United States
(12) Patent Application Publication
(10) Pub. No.: US 2004/0091242 A1
(43) Pub. Date: May 13, 2004

(54) Video recording method for rewriteable optical disks

(76) Inventors: Yung-Chiuan Weng, Taipei (TW); Chia-Ho Lin, Taipei (TW)

Correspondence Address: HARNESS, DICKEY & PIERCE, P.L.C., P.O. BOX 8910, RESTON, VA, 20195, US

(21) Appl. No.: 10/292,477

(22) Filed: Nov. 13, 2002

(51) Int. Cl. H04N 5/781

(52) U.S. Cl. 386/52; 386/125

(57) ABSTRACT

A video recording method for rewriteable optical disks is disclosed. By recording the free space in a recording medium, the method enables the user to record new data through an optimized recording space combination, fully utilizing available space inside the recording medium. When images are recorded in a fragmented recording medium, the invention further provides the function of defragmenting the fragmented image sections, ensuring the wholeness of the recording space and the smoothness in video playing.

### BACKGROUND OF THE INVENTION

1. Field of Invention

The invention pertains to a video recording method implemented through computer software. In particular, the invention relates to a method applied to recording media that automatically optimizes image storage according to the available free space on the recording medium and the length of the contents to be recorded.

2. Related Art

With the mature recording techniques and increase in multimedia applications, the conventional analogue video recording technology is not able to satisfy the needs of many video players. In replacement is the completely digitized DVD video recording (VR) technique for digital versatile discs or digital video discs (DVD's).

Since the digital recording media have the desirable feature of random data access, they can provide in principle arbitrary nonlinear video editing for the video players. However, the available hardware products with digital VR functions on the market still stay at the old linear video editing stage. When these linear video editing techniques are applied to digital recording media, the advantages of the digital media in video editing cannot be seen at all, not to mention using computer software to achieve breakthroughs in digital VR techniques.

Therefore, how to use the current computer software technology to make breakthroughs in the conventional video editing and to fully make use of the advantages of digital video, so that the user can perform nonlinear VR on digital recording media is of great importance. It is highly desirable to further provide suggestions of optimized video recording so as to completely use the available space in digital recording media. Such directions are currently considered by many companies that devote to computer software development for VR and will be the trend of future digital VR technology.

### SUMMARY OF THE INVENTION

In view of the foregoing, the invention provides a video recording method for rewriteable optical disks.

A primary objective of the invention is to find an optimized recording space combination for video data storage according to recorded information of the available space on the recording medium along with the video content size or system selection criteria. This can achieve the goal of fully utilizing the available space on recording media.

Moreover, to avoid disassociated video data storage that will result in user's inconvenience in video playing, the invention further provides a defragment technique for video recording sectors, reaching the goals of having undivided video recording space and fluency in video playing.

To achieve the above objectives, the invention provides a video recording system for reqriteable optical disks, which contains an operation module, an extraction module, a record module, and a recording module.

When the scheduled recording time of a source video file is known, the disclosed video recording method for rewriteable optical disks contains the following steps. First, the method selects a source video to begin the burning process. The scheduled recording time of the source video file is detected. Afterwards, the system reads an available sector table of the recording medium. Selection criteria are then used to optimize the recording sector. Then the burnin procedure starts. Finally, the system defragments the burned sectors and updates the available sector table.

The disclosed video recording method for rewriteable optical disks has the following steps when no scheduled recording time of source video files is known. First, the burning process is initiated. The system reads the available sector table of the recording medium. Selection criteria are then used to determine an available sector. Then the burning process starts. When the available sector is recorded over, the system looks for another available sector from the available sector table to continue the burning process. Finally, the system performs burned defragmentation and updates the available sector table.

### BRIEF DESCRIPTION OF THE DRAWINGS

The invention will become more fully understood from the detailed description given hereinbelow illustration only, and thus are not limitative of the present invention, and wherein:

FIG. 1 shows the system operation structure of the video recording method for rewriteable optical disks;

FIG. 2 shows the flowchart of the video recording method for rewriteable optical disks in the case of knowing the recording time; and

FIG. 3 shows the flowchart of the video recording method for rewriteable optical disks in the case of not knowing the recording time.

### DETAILED DESCRIPTION OF THE INVENTION

This specification discloses a video recording method for rewriteable optical disks. The method is implemented using computer software. The image files are recorded by optimizing the recording space combination. Since the recording medium has the feature of random daa access, the available space in the recording medium may become fragmented after frequent reading and writing. Therefore, the invention can fully make use of all available space in the recording medium.

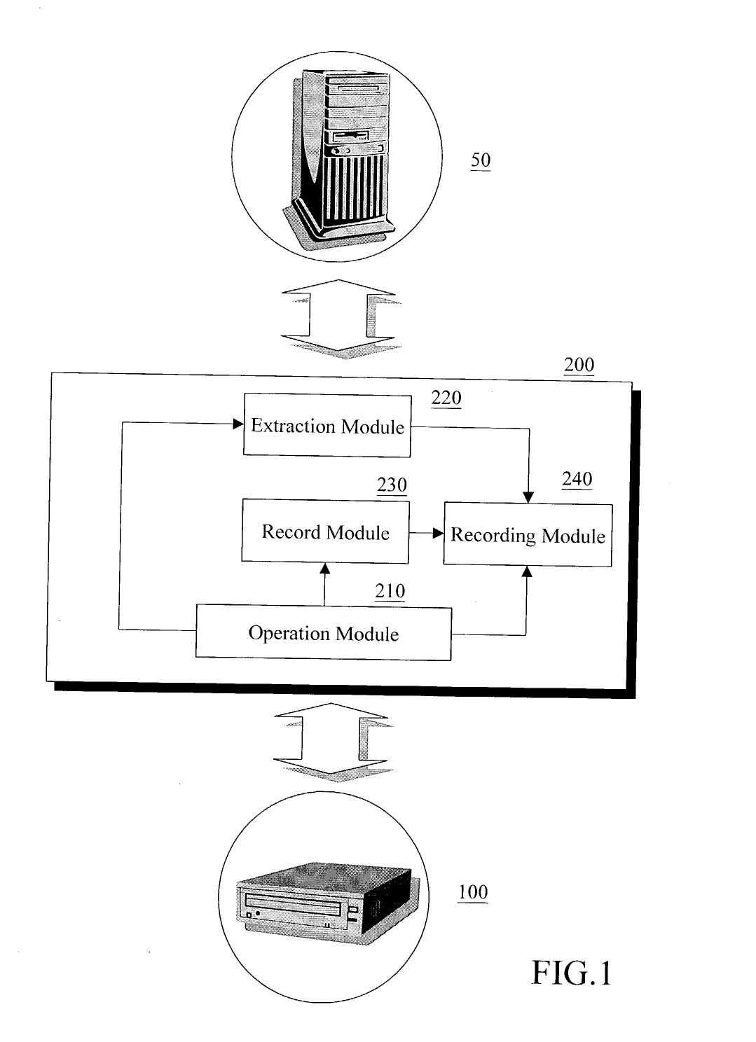

We use FIG. 1 to explain the operation structure of the system. Basically, source video files originally on a computer executable platform 50 are stored to a recording medium in a recording medium device 100 through the disclosed video recording system 200. The structure of the video recording system 200 contains the following modules.

(1) Operation module 210. This module generates a user interface when the video recording system 200 is runing for the user to make operations during the video recording process. Such operations include the selection of source video files, setting of burning process parameters, and controlling of the burning process.

(2) Extraction module 220. This module extracts from the computer executable platform 50 a source video file that the user wants to use for video recording. It further detects the scheduled burnin time of the source video file. In particular, the source video file selected by the user can be a continuous video file comprised of video sections of a single or muliple sources.

(3) Record module 230. This module stores the space record of the recording medium according to the user's operation. An available sector table is used to do the bookkeeping in the video recording system 200. The table contains fields recording the name of the recording medium, the sector number, the initialization position of the sector, the recordable time of the sector, and the title of the recorded content. It is used to stored information about all available space in each recording medium.

In addition, the record module 230 further provides an optimal recording sector combination according to selection criteria set beforehand (if the video recording system 200 already knows the recording time) or available space (if the video recording system 200 does not know the recording time). Basically, the sector number and the recording time of the sectors are the main selection criteria. When the system already knows the recording time, a single sector with the most appropriate available recording time (or multiple sector combinations) is chosen with the highest priority. When the system does not know the recording time, the first available sector (i.e. the one with a smaller sector number and an earliest sector initialization position) is chosen for recording. When the sector is runing out of space, the recording process continues to the next sector.

(4) Recording module 240. This module executes the video recording procedure according to the user's operation. After the video recording is completed, the module further performs a recorded sector defragmentation process. The so-called recorded sector defragmentation process is similar to the usual defragmentation or disk file systems. In the invention, the sectors of the same video file separately disrtibuted in the recording medium are rearranged, so that a video file is stored in a continuous recording sector. The technology of this part is well-known and thus not repeated herein.

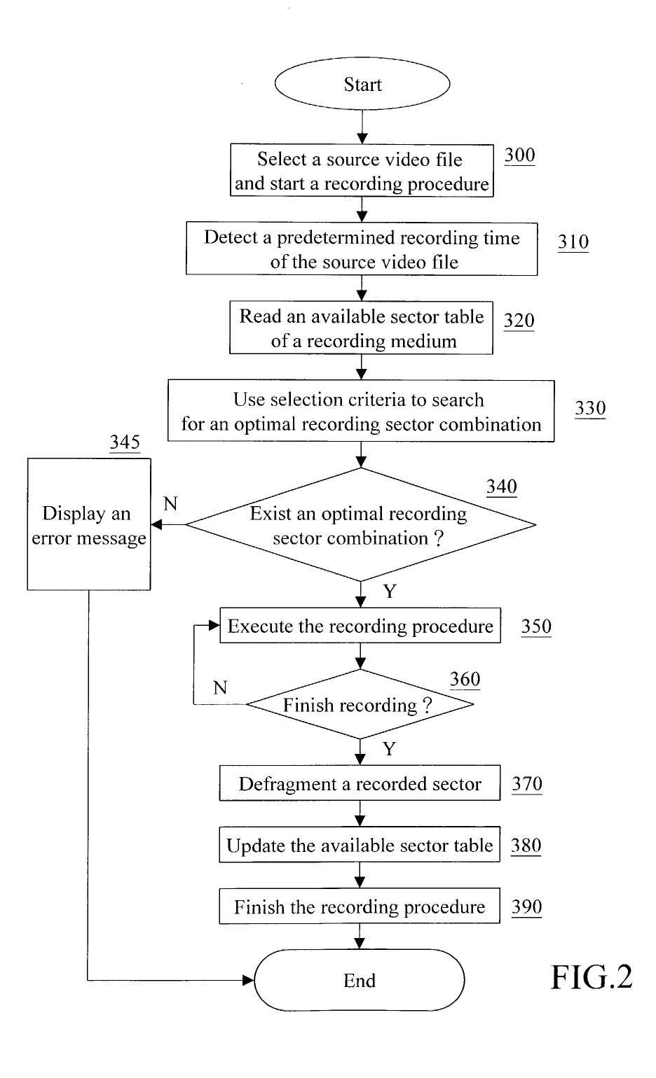

When the recording time is known, the video recording method for rewriteable optical disks has the recording procedure shown in FIG. 2. First, the user selects via the user interface a particular source video file from a computer executable platform 50. The source video file can be comprised of a single or multiple video sections. Then the recording procedure starts (step 300). The disclosed video recording system 200 uses the extraction module 220 to detect the size of the source video file, determining the length of the recording time (step 310). The system then reads the available sector table (recording all available sector information) of the recording medium from the record module 230 (step 320). The preset selection criteria are then used to determine an optimal recording sector combination (which may be composed of a single or several sectors) (step 330). According to the predetermined recording time, an available sector with the appropriate recording time and the smallest sector number is found from the available sector table to continue the recording procedure. If the optimal recording sector combination does not exist (step 340), then the recording procedure requested by the user cannot be fulfilled on the recording medium. An error message will be prompted to the user (step 345). If such an optimal recording sector combination exists, the video recording system 200 starts the recording procedure (step 350). During the process, the video recording system 200 continues checking whether the recording is finished (step 360). If not, then the system continues step 350. Once it is finished, the system starts the defragmentation process for the recorded sectors (step 370). The defragmentation of the recorded sectors refers to move a video file distributed in several disjoint sectors into a continiuous sector. Once the defragmentation is finished, the video recording system 200 starts to update the available sector table to record the status of the final available sectors in the recording medium (step 380). Finally, the whole recording procedure for a known recording time is over (step 390).

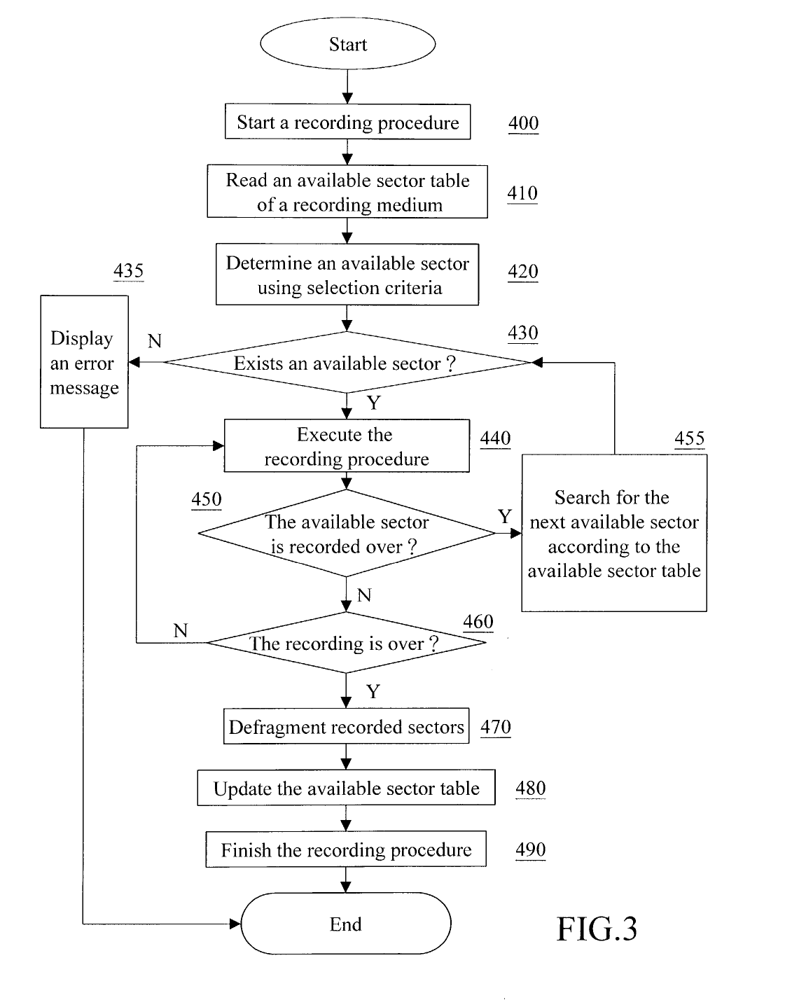

When the recording time is unknown, the disclosed video recording method for rewriteable optical disks is shown in FIG. 3. When the user starts the recording procedure (step 400), the recording system 200 reads the available sector table of the recording medium from the record module 230 (step 410). Afterwards, selection criteria are used to determine an available sector for performing the recording procedure (step 420). In this case, since the recording time is unknown, the selection criterion is the available sector with the earliest initilization position (i.e. the one with the smallest sector number). If there is no available sector in the recording medium (step 430), the video recording system 200 displays an error message to the user (step 435). If there is an available sector, the system starts the recording procedure (step 440). During the recording process, the system keeps monitoring whether the available sector is recorded over (step 450). Once the selected available sector is recorded over, the system seaches the next available sector according to the available sector table to continue the recording procedure (step 455). Similarly, if no available sector exists (step 430), the video recording system 200 displays an error message to the user (step 435). If the available sector being used is large enough, then the system determines whether the recording is over (step 460). If the recording procedure is not finished, the system continues with step 440. Once the recording is done, the system starts the defragmentation process for recorded sectors (step 470) and then updates the available sector table (step 480). Finally, the recording procedure for unknown recording time is completed (step 490).

### Effects of the Invention

The disclosed video recording method for rewriteable optical disks automatically searches for an optimal recording sector combination from the recording medium. It does not only make good use of the fragmented sectors in the recording medium, but also save the user a lot of time in searching.

To avoid discontinuous playing of a video file because it is stored in many fragmented sectors, the invention further provides the function of defragmentation for fragmented video sectors. Therefore, video files distributed among fragmented sectors can be moved together to a continuous video sector so that the video player can run more smoothly.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A video recording system for rewriteable optical disks running a computer software to provide an optimization of video recording sector combination for video recording according to the available sectors in a recording medium, the system comprising:
an operation module, which generates a user interface for the user to perform operations during the video recording procedure;
an extraction module, which extracts a source video file from a computer executable platform according to the user's operation for subsequent video recording and detects a predetermined recording time of the source video file;
a record module, which records the available sectors in the recording medium in an available sector table and, during video recording, uses a selection criterion to form an optimal recording sector combination and an available sector; and
a recording module, which executes the video recording procedure according to the user's operation and performs defragmentation for recorded sectors after the video recording is finished.

2. The system of claim 1, wherein the recording medium has the property of random data access and is placed in a recording medium device for carrying out the video recording procedure.

3. The system of claim 1, wherein the available sector table contains fields consisting of a recording medium name, a sector number, a sector initialization position, recordable time of a sector, and a recorded content title.

4. The system of claim 1, wherein the selection criteria include the sector number in the available sector table and the recordable time of the sector, the available sector with the earliest initialization position and sufficient recording time having the highest priority.

5. The system of claim 1, wherein the optimal recording sector combination is a combination of a plurality of available sectors with a total recordable time greater than or equal to the predetermined recording time.

6. A video recording method for rewriteable optical disks running a computer software to provide an optimization of video recording sector combination for video recording according to the available sectors in a recording medium, the method comprising the steps of:
selecting a source video file to start a recording procedure;
detecting a predetermined recording time of the source video file;
reading an available sector table of a recording medium;
searching for an optimal recording sector combination according to a selection criterion;
executing the recording procedure;
defragmenting recorded sectors; and
updating the available sector table.

7. The method of claim 6, wherein the recording medium has the property of random data access and is placed in a recording medium device for carrying out the video recording procedure.

8. The method of claim 6, wherein the available sector table contains fields consisting of a recording medium name, a sector number, a sector initialization position, recordable time of a sector, and a recorded content title.

9. The method of claim 6, wherein the selection criterion is based upon the sector number and the recordable time of the sector.

10. The method of claim 6, wherein the optimal recording sector combination is a combination of a plurality of available sectors with a total recordable time greater than or equal to the predetermined recording time.

11. The method of claim 6, wherein the defragmentation of the recorded sectors moves a plurality of fragmented sectors of a same video file to a continuous sector.

12. The method of claim 6 further comprising the step of prompting an error message to the user when no optimal recording sector combination exists.

13. A video recording method for rewriteable optical disks running a computer software to search for available space on a recording medium during the video recording, the method comprising the steps of:
starting a recording procedure;
reading an available sector table of a recording medium;
determining an available sector according to a selection criterion;
executing the recording procedure;
recording the available sector over;
searching for the next available sector according to the available sector table to continue recording;
defragmenting recorded sectors; and
updating the available sector table.

14. The method of claim 13, wherein the recording medium has the property of random data access and is placed in a recording medium device for carrying out the video recording procedure.

15. The method of claim 13, wherein the available sector table contains fields consisting of a recording medium name, a sector number, a sector initialization position, recordable time of a sector, and a recorded content title.

16. The method of claim 13, wherein selection criteria include the sector number in the available sector table and the recordable time of the sector, the available sector with the earliest initialization position and sufficient recording time having the highest priority.

17. The method of claim 13, wherein the defragmentation of the recorded sectors moves a plurality of fragmented sectors of a same video file to a continuous sector.

18. The method of claim 13 further comprising the step of prompting an error message to the user when no optimal recording sector combination exists.
